(19) United States
(12) Patent Application Publication
(10) Pub. No.: US 2025/0171625 A1
(43) Pub. Date: May 29, 2025

(54) THERMOPLASTIC VULCANIZATE POLYMERIC MATERIALS FOR HIGH-VOLTAGE HOUSINGS

(71) Applicant: Aclara Technologies LLC, St. Louis, MO (US)

(72) Inventor: Nejib Masghouni, Alpharetta, GA (US)

(21) Appl. No.: 18/961,704

(22) Filed: Nov. 27, 2024

Related U.S. Application Data
(60) Provisional application No. 63/603,474, filed on Nov. 28, 2023.
(60) Provisional application No. 63/616,384, filed on Dec. 29, 2023.
(60) Provisional application No. 63/619,208, filed on Jan. 9, 2024.

(51) Int. Cl. C08L 23/0853; C08L 23/06; C08L 83/04; H01B 17/56

(52) U.S. Cl. CPC C08L 23/0853; C08L 23/06; C08L 83/04; H01B 17/56; C08L 2203/20; C08L 2203/30

(57) ABSTRACT

Disclosed herein are high-voltage assemblies that take advantage of a thermoplastic vulcanizate to improve performance and ease of manufacture. An example high-voltage assembly includes a component capable of operating in a high-voltage environment, and a thermoplastic vulcanizate housing that encloses the component. Also disclosed herein are methods of making the thermoplastic vulcanizate and the high-voltage assembly.

### CROSS-REFERENCE TO RELATED APPLICATIONS

This application claims priority to U.S. Provisional Patent Application No. 63/603,474 filed on Nov. 28, 2023, U.S. Provisional Patent Application No. 63/616,384 filed on Dec. 29, 2023, and U.S. Provisional Patent Application No. 63/619,208 filed on Jan. 9, 2024, each of which is incorporated fully herein by reference.

### TECHNICAL FIELD

This disclosure relates to thermoplastic vulcanizate polymeric materials that can be used in high-voltage assemblies.

### INTRODUCTION

Polymeric high-voltage housing materials are currently based on thermosetting polymers, such as elastomers like EPDM and silicone, which require the elastomer to be crosslinked. Because of this requirement, the elastomers are processed in highly specialized equipment, which can often take excessive amounts of time to make a product. In addition, the elastomer may not be recycled and reused, which can incur additional production cost. Accordingly, improved materials may be useful in overcoming or limiting these issues.

### SUMMARY

In one aspect, described herein are high-voltage assemblies including: a component capable of operating in a high-voltage environment; and a housing at least partially enclosing the component, the housing including a thermoplastic vulcanizate.

In one aspect, described herein are high-voltage assemblies including: a component capable of operating in a high-voltage environment; and a housing at least partially enclosing the component, the housing consisting essentially of a thermoplastic vulcanizate and an optional functional filler.

In one aspect, described herein are methods of making a high-voltage assembly, the method including: providing a thermoplastic vulcanizate; and overmolding the thermoplastic vulcanizate onto a component capable of operating in a high-voltage environment.

### BRIEF DESCRIPTION OF THE DRAWINGS

FIG. 1 shows an example high-voltage assembly.

FIG. 2 shows a schematic depiction of different material phases of disclosed thermoplastic vulcanizates (TPVs).

FIG. 3 shows a flowchart of an example method for producing disclosed thermoplastic vulcanizates.

### DETAILED DESCRIPTION

Disclosed herein are thermoplastic vulcanizates that can be used in high-voltage applications. Elastomer material can be mixed with a thermoplastic material. While the material can possess some of the properties of the soft elastomeric phase, it can be processed in any typical plastic molding machine. Plastic molding machines are commonly used and could make plastic parts at a much faster rate. In addition, the thermoplastic vulcanizate can be recyclable, which can reduce the total cost of production. Finally, the thermoplastic vulcanizate can be safely stored for longer times (typically years) compared to current thermosetting elastomers (typically weeks).

### 1. DEFINITIONS

Unless otherwise defined, all technical and scientific terms used herein have the same meaning as commonly understood by one of ordinary skill in the art. In case of conflict, the present document, including definitions, will control. The materials, methods, and examples disclosed herein are illustrative only and not intended to be limiting. Methods and materials similar or equivalent to those described herein can be used in practice or testing of the disclosed technology. All publications, patent applications, patents and other references mentioned herein are incorporated by reference in their entirety.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The terms “mounted,” “connected,” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated, and for the range 1.5-2, the numbers 1.5, 1.6, 1.7, 1.8, 1.9, and 2 are contemplated.

### 2. HIGH-VOLTAGE ASSEMBLIES

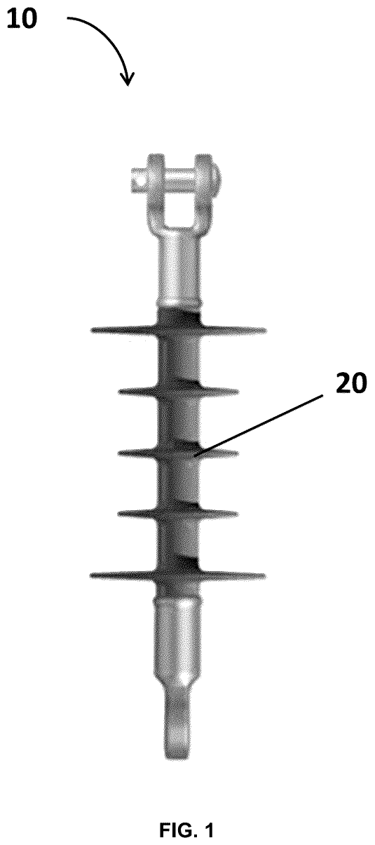

Disclosed herein are high-voltage assemblies that include a thermoplastic vulcanizate as a housing material for a high-voltage component. For example, the high-voltage assembly can include a component capable of operating in a high-voltage environment (e.g., about 1 kV to about 765 kV), and a housing at least partially enclosing the component, where the housing includes a thermoplastic vulcanizate. In some embodiments, the housing encloses the component in its entirety. An example high-voltage assembly can be seen in FIG. 1. In the illustrated embodiment, the high-voltage assembly 10 is a deadend insulator that includes a thermoplastic vulcanizate housing 20 enclosing a fiber glass rod, which is not shown.

Any type of high-voltage component, e.g., that can be used in electrical power transmission and distribution systems, can be used in the high-voltage assembly. Example components include, but are not limited to, an arrester, a transmission and distributor insulator, a polymer cut-out, a fusing, a bushing, and an interrupter. A high-voltage arrester is a protective device for limiting voltage on equipment by discharging or bypassing surge current. A high-voltage insulator is a device used to isolate the electrical conductors from the tower on the ground. A fuse cutout is a device used to protect distribution transformers from current surges and overloads. High-voltage components can be graded to operate in a particular high-voltage environment, which is typically provided by the supplier.

The high-voltage component is capable of operating in environments with varying high-voltages. For example, the component can be capable of operating in an environment of about 1 kV to about 765 kV, such as about 10 kV to about 765 kV, about 20 kV to about 765 kV, about 50 kV to about 765 kV, about 75 kV to about 765 kV, about 100 kV to about 765 kV, about 200 kV to about 765 kV, about 300 kV to about 765 kV, about 500 kV to about 765 kV, about 1 kV to about 50 kV, about 1 kV to about 500 kV, about 10 kV to about 500 kV, or about 100 kV to about 600 kV. In some embodiments, the component is capable of operating in an environment with a voltage of greater than 1 kV, greater than 10 kV, greater than 50 kV, greater than 75 kV, greater than 100 kV, greater than 150 kV, greater than 200 kV, greater than 250 kV, greater than 300 kV, greater than 350 kV, greater than 400 kV, greater than 450 kV, or greater than 500 kV. In some embodiments, the component is capable of operating in an environment with a voltage of less than 800 kV, less than 775 kV, less than 765 kV, less than 750 kV, or less than 700 kV.

The housing includes a thermoplastic vulcanizate. In some embodiments, the housing consists essentially of a thermoplastic vulcanizate. In some embodiments, the housing consists of a thermoplastic vulcanizate. The thermoplastic vulcanizate includes a thermoplastic and an elastomer. Thermoplastics are polymers that can be remelted at elevated temperatures and reshaped and reused. Elastomers are rubbery materials that are viscoelastic and, in some instances, can be at least partially cured. Both the thermoplastic and the elastomer can be commercially purchased.

Due to the inclusion of the thermoplastic and the elastomer, the thermoplastic vulcanizate can have beneficial properties arising from both of these individual polymers. For example, the thermoplastic vulcanizate can possess the properties of rubber (e.g., cross-linked rubber) like elasticity, flexibility, strength, and solvent resistance. The thermoplastic vulcanizate can also exhibit the processing properties of thermoplastics, e.g., solid at room temperature and can melt at elevated temperatures, as well as can be recyclable. Accordingly, in some embodiments, the housing is recyclable.

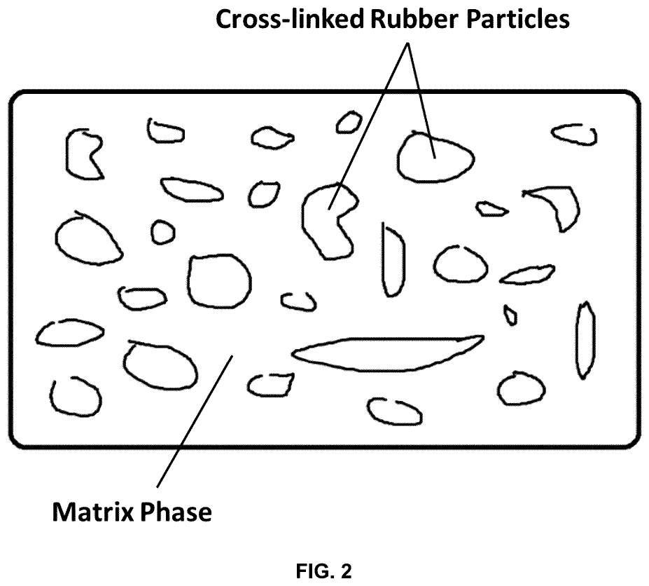

The thermoplastic vulcanizate can include the thermoplastic and the elastomer in different phases. For example, the thermoplastic vulcanizate can include two or more polymer phases, where one phase can be a continuous hard plastic phase, while the other can be a discontinuous soft elastomeric phase. Accordingly, the thermoplastic vulcanizate can include a continuous thermoplastic matrix and a discontinuous elastomeric phase dispersed in the thermoplastic matrix. This aforementioned thermoplastic vulcanizate morphology is depicted in FIG. 2, where cross-linked rubber particles are schematically shown to make up the discontinuous elastomeric phase.

Generally, any thermoplastic suitable for use in the manufacture of thermoplastic vulcanizates can be used as the thermoplastic. Example thermoplastics include, but are not limited to, a polyolefin (e.g., polypropylene, polyethylene, high density polyethylene, etc.), a polyimide, a polyester, a polyamide (e.g., nylon 6, nylon 12, etc.), poly(phenylene ether), copolymers of a polyolefin and vinyl acetate (e.g., ethylene-co-vinyl acetate), a polycarbonate, a styrene-acrylonitrile copolymer, polyethylene terephthalate, polybutylene terephthalate, polystyrene, polystyrene derivatives, polyphenylene oxide, polyoxymethylene, fluorine-containing thermoplastic resins, and combinations thereof. In some embodiments, the thermoplastic is selected from the group consisting of polypropylene, nylon, polyethylene, and ethylene-co-vinyl acetate. In some embodiments, the thermoplastic comprises ethylene-co-vinyl acetate or polyethylene. In some embodiments, the thermoplastic is ethylene-co-vinyl acetate or polyethylene.

The thermoplastic vulcanizate can include the thermoplastic at varying amounts. For example, the thermoplastic vulcanizate can include the thermoplastic at about 10 weight percent (wt %) to about 90 wt % based on the total weight of the thermoplastic vulcanizate, such as about 15 wt % to about 85 wt % based on the total weight of the thermoplastic vulcanizate, about 20 wt % to about 80 wt % based on the total weight of the thermoplastic vulcanizate, about 30 wt % to about 70 wt % based on the total weight of the thermoplastic vulcanizate, about 30 wt % to about 80 wt % based on the total weight of the thermoplastic vulcanizate, about 40 wt % to about 60 wt % based on the total weight of the thermoplastic vulcanizate, about 10 wt % to about 50 wt % based on the total weight of the thermoplastic vulcanizate, or about 50 wt % to about 90 wt % based on the total weight of the thermoplastic vulcanizate.

In some embodiments, the thermoplastic vulcanizate includes greater than 10 wt % of the thermoplastic, greater than 15 wt % of the thermoplastic, greater than 20 wt % of the thermoplastic, greater than 30 wt % of the thermoplastic, greater than 40 wt % of the thermoplastic, or greater than 50 wt % of the thermoplastic based on the total weight of the thermoplastic vulcanizate. In some embodiments, the thermoplastic vulcanizate includes less than 90 wt % of the thermoplastic, less than 80 wt % of the thermoplastic, less than 70 wt % of the thermoplastic, less than 60 wt % of the thermoplastic, less than 50 wt % of the thermoplastic, or less than 40 wt % of the thermoplastic based on the total weight of the thermoplastic vulcanizate.

Generally, any elastomer suitable for use in the manufacture of thermoplastic vulcanizates can be used as the elastomer. Example elastomers include, but are not limited to, silicone, ethylene propylene diene monomer (EPDM), ethylene propylene rubber (EPM), fluorosilicone, polyvinylidene difluoride, natural rubber, nitrile butadiene rubber, and combinations thereof. In some embodiments, the elastomer is selected from the group consisting of silicone, ethylene propylene diene monomer (EPDM), ethylene propylene rubber (EPM), fluorosilicone, polyvinylidene difluoride, natural rubber, and nitrile butadiene rubber. In some embodiments, the elastomer comprises silicone. In some embodiments, the elastomer is silicone.

The thermoplastic vulcanizate can include the elastomer at varying amounts. For example, the thermoplastic vulcanizate can include the elastomer at about 10 wt % to about 90 wt % based on the total weight of the thermoplastic vulcanizate, such as about 15 wt % to about 85 wt % based on the total weight of the thermoplastic vulcanizate, about 20 wt % to about 80 wt % based on the total weight of the thermoplastic vulcanizate, about 30 wt % to about 70 wt % based on the total weight of the thermoplastic vulcanizate, about 40 wt % to about 60 wt % based on the total weight of the thermoplastic vulcanizate, about 10 wt % to about 50 wt % based on the total weight of the thermoplastic vulcanizate, about 25 wt % to about 50 wt % based on the total weight of the thermoplastic vulcanizate, or about 50 wt % to about 90 wt % based on the total weight of the thermoplastic vulcanizate.

In some embodiments, the thermoplastic vulcanizate includes the elastomer at greater than 10 wt %, greater than 15 wt %, greater than 20 wt %, greater than 30 wt %, greater than 40 wt %, or greater than 50 wt %, based on the total weight of the thermoplastic vulcanizate. In some embodiments, the thermoplastic vulcanizate includes the elastomer at less than 90 wt %, less than 80 wt %, less than 70 wt %, less than 60 wt %, less than 50 wt %, or less than 40 wt %, based on the total weight of the thermoplastic vulcanizate.

Different fillers can also be mixed in during the vulcanization process to provide added functionality to the thermoplastic vulcanizate and housing thereof. Example functional fillers include, but are not limited to, flame retardants, ultra-violet (UV) protectants, chemical stabilizers, heat stabilizers, compatibilizers, plasticizers, and combinations thereof. The thermoplastic vulcanizate can include the functional filler at about 0.1 wt % to about 5 wt % based on the total weight of the thermoplastic vulcanizate, such as about 0.2 wt % to about 4.5 wt % based on the total weight of the thermoplastic vulcanizate, about 0.3 wt % to about 4 wt % based on the total weight of the thermoplastic vulcanizate, about 0.4 wt % to about 4 wt % based on the total weight of the thermoplastic vulcanizate, about 0.5 wt % to about 3.5 wt % based on the total weight of the thermoplastic vulcanizate, about 0.1 wt % to about 2.5 wt % based on the total weight of the thermoplastic vulcanizate, or about 1.5 wt % to about 5 wt % based on the total weight of the thermoplastic vulcanizate.

In some embodiments, the thermoplastic vulcanizate includes the functional filler at greater than 0.1 wt %, greater than 0.2 wt %, greater than 0.3 wt %, greater than 0.4 wt %, greater than 0.5 wt %, greater than 1 wt %, or greater than 2 wt %, based on the total weight of the thermoplastic vulcanizate. In some embodiments, the thermoplastic vulcanizate includes the functional filler at less than 5 wt %, less than 4 wt %, less than 3.5 wt %, less than 3 wt %, less than 2.5 wt %, less than 2 wt %, or less than 1 wt %, based on the total weight of the thermoplastic vulcanizate.

### A. Example Embodiments

In some embodiments, the high-voltage assembly comprises a component capable of operating in a high-voltage environment of about 25 kV to about 765 kV; and a housing at least partially enclosing the component, the housing comprising a thermoplastic vulcanizate of silicone and ethylene-co-vinyl acetate.

In some embodiments, the high-voltage assembly comprises a component capable of operating in a high-voltage environment of about 1 kV to about 765 kV; and a housing at least partially enclosing the component, the housing comprising a thermoplastic vulcanizate having about 30 wt % to about 50 wt % silicone and about 30 wt % to about 50 wt % ethylene-co-vinyl acetate, where wt % is based on the total weight of the thermoplastic vulcanizate.

In some embodiments, the high-voltage assembly comprises a component capable of operating in a high-voltage environment of about 1 kV to about 765 kV; and a housing at least partially enclosing the component, the housing comprising a thermoplastic vulcanizate having about 25 wt % to about 35 wt % silicone and about 60 wt % to about 80 wt % polyethylene, where wt % is based on the total weight of the thermoplastic vulcanizate.

In some embodiments, the high-voltage assembly comprises a component capable of operating in a high-voltage environment of about 100 kV to about 765 kV; and a housing at least partially enclosing the component, the housing consisting essentially of a thermoplastic vulcanizate and an optional functional filler.

In some embodiments, the high-voltage assembly comprises a component capable of operating in a high-voltage environment of about 1 kV to about 765 kV; and a housing at least partially enclosing the component, the housing consisting essentially of a thermoplastic vulcanizate and an optional functional filler, wherein the thermoplastic vulcanizate comprises about 30 wt % to about 80 wt % of the thermoplastic and about 25 wt % to about 50 wt % of the elastomer, where wt % is based on the total weight of the thermoplastic vulcanizate.

In some embodiments, the thermoplastic vulcanizate comprises, by weight of the thermoplastic vulcanizate, about 40 wt % silicone, about 40 wt % ethylene-co-vinyl acetate, and about 20 wt % functional filler.

In some embodiments, the thermoplastic vulcanizate comprises, by weight of the thermoplastic vulcanizate, about 28 wt % silicone, about 70 wt % polyethylene, and about 2 wt % functional filler.

In some embodiments, the thermoplastic vulcanizate consists essentially of silicone, ethylene-co-vinyl acetate, and a functional filler.

### 3. METHODS OF MAKING THE HIGH-VOLTAGE ASSEMBLIES

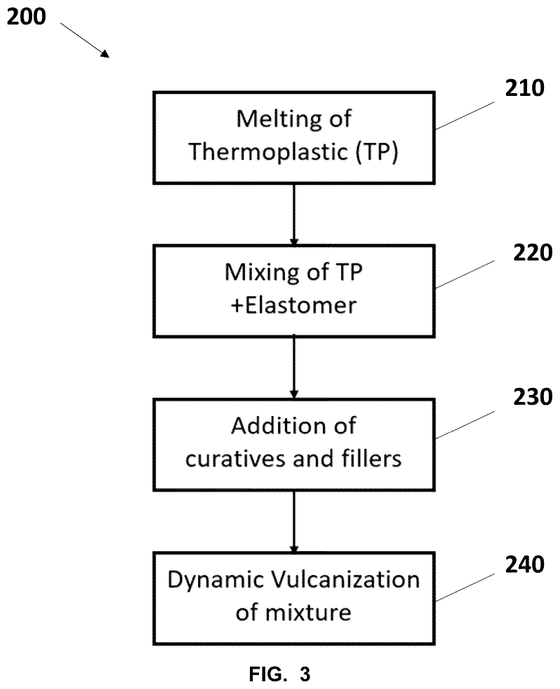

Further disclosed herein are methods of making the high-voltage assemblies. As an initial step, the method can include providing the thermoplastic vulcanizate for the housing. FIG. 3 illustrates an example method 200 for making the thermoplastic vulcanizate. Generally, the method includes, at step 210, melting the thermoplastic. The method further includes, at step 220, mixing the thermoplastic and the elastomer to provide a mixture. The mixture can then be, at step 230, combined with any functional fillers and/or curatives. The mixture can then undergo, at step 240, vulcanization (e.g., dynamic vulcanization—where mixing and cross-linking happen simultaneously), thereby at least partially crosslinking the elastomer to provide the thermoplastic vulcanizate. Vulcanization of the elastomer can take place during the melt mixing at elevated temperatures where the thermoplastic can be a semi-crystalline matrix phase. In addition, vulcanization can be done with a crosslinker to make stable and durable rubber in the thermoplastic vulcanizate.

The method can further include processing the thermoplastic vulcanizate, e.g., by overmolding the thermoplastic vulcanizate to provide a housing over the high-voltage component. Overmolding results in the high-voltage component being at least partially enclosed by the thermoplastic vulcanizate housing. The overmolding process can be altered to enclose varying amounts of the high-voltage component at varying levels of thickness. Both enclosure and thickness of the housing can be adapted per the requirements of the application. In addition, the thermoplastic vulcanizate can allow the housing and high-voltage assembly thereof to be made with a significantly faster processing time compared to traditionally used elastomers.

In some embodiments, an adhesive is applied to a surface of the component prior to the thermoplastic vulcanizate being overmolded. The adhesive can aid in creating a more stable interface between the housing and the high-voltage component. Example adhesives include, but are not limited to, epoxy and polyurethane based adhesives.

The disclosed technology has multiple aspects, illustrated by the following non-limiting examples.

### 4. EXAMPLES

### Example 1

### Example High-Voltage Insulator

An example method of making a high-voltage insulator is described herein. First, a structural rod including an epoxy resin and fiberglass (e.g., E-CR fiberglass) is made with a pultrusion process. Next, stainless steel metal end fittings are crimped at the end of the fiberglass rods with a crimping machine. An epoxy-based adhesive is then applied manually on the fiberglass rod. Finally, the housing material including 70% polyethylene+28% silicone+2% functional filler is overmolded on the fiberglass rod in an injection molding machine.

For reasons of completeness, various aspects of the disclosure are set out in the following numbered clauses:

Clause 1. A high-voltage assembly comprising: a component capable of operating in a high-voltage environment; and a housing at least partially enclosing the component, the housing comprising a thermoplastic vulcanizate.

Clause 2. The high-voltage assembly of clause 1, wherein the high-voltage environment is about 1 kV to about 765 kV.

Clause 3. The high-voltage assembly of clause 1 or 2, wherein the high-voltage environment is about 100 kV to about 765 kV.

Clause 4. The high-voltage assembly of any one of clauses 1-3, wherein the thermoplastic vulcanizate comprises a thermoplastic and an elastomer.

Clause 5. The high-voltage assembly of clause 4, wherein the thermoplastic is selected from the group consisting of polypropylene, nylon, polyethylene, and ethylene-co-vinyl acetate.

Clause 6. The high-voltage assembly of clause 5, wherein the thermoplastic is ethylene-co-vinyl acetate or polyethylene.

Clause 7. The high-voltage assembly of any one of clauses 4-6, wherein the thermoplastic vulcanizate comprises the thermoplastic at about 10 weight percent (wt %) to about 90 wt % based on the total weight of the thermoplastic vulcanizate.

Clause 8. The high-voltage assembly of clause 4, wherein the elastomer is selected from the group consisting of silicone, ethylene propylene diene monomer (EPDM), ethylene propylene rubber (EPM), fluorosilicone, polyvinylidene difluoride, natural rubber, and nitrile butadiene rubber.

Clause 9. The high-voltage assembly of clause 8, wherein the elastomer is silicone.

Clause 10. The high-voltage assembly of any one of clauses 4 and 8-9, wherein the thermoplastic vulcanizate comprises the elastomer at less than 50 wt % based on the total weight of the thermoplastic vulcanizate.

Clause 11. The high-voltage assembly of any one of clauses 4 and 8-10, wherein the thermoplastic vulcanizate comprises the elastomer at about 10 wt % to about 90 wt % based on the total weight of the thermoplastic vulcanizate.

Clause 12. The high-voltage assembly of any one of clauses 4 and 8-11, wherein the elastomer is at least partially cured.

Clause 13. The high-voltage assembly of any one of clauses 4-12, wherein the thermoplastic vulcanizate comprises silicone and ethylene-co-vinyl acetate.

Clause 14. The high-voltage assembly of any one of clauses 1-13, wherein the thermoplastic vulcanizate comprises a functional filler selected from the group consisting of a flame retardant, a chemical stabilizer, a UV protectant, a heat stabilizer, a compatibilizer, a plasticizer, and a combination thereof.

Clause 15. The high-voltage assembly of any one of clauses 1-14, wherein the housing is recyclable.

Clause 16. The high-voltage assembly of any one of clauses 1-15, wherein the component is an arrester, a transmission and distributor insulator, a polymer cut-out, a fusing, a bushing, or an interrupter.

Clause 17. The high-voltage assembly of clause 16, wherein the component is a transmission and distributor insulator.

Clause 18. A high-voltage assembly comprising: a component capable of operating in a high-voltage environment; and a housing at least partially enclosing the component, the housing consisting essentially of a thermoplastic vulcanizate and an optional functional filler.

Clause 19. A method of making a high-voltage assembly, the method comprising: providing a thermoplastic vulcanizate; and overmolding the thermoplastic vulcanizate onto a component capable of operating in a high-voltage environment.

Clause 20. The method of clause 19, wherein providing the thermoplastic vulcanizate comprises mixing a thermoplastic and an elastomer to provide a mixture and dynamically vulcanizing the mixture to provide the thermoplastic vulcanizate.

Although some aspects have been described in detail with reference to certain example embodiments, variations and modifications exist within the scope and spirit of one or more independent aspects as described. Various features and advantages are set forth in the following claims.

What is claimed is:

1. A high-voltage assembly comprising:
a component capable of operating in a high-voltage environment; and
a housing at least partially enclosing the component, the housing comprising a thermoplastic vulcanizate.

2. The high-voltage assembly of claim 1, wherein the high-voltage environment is about 1 kV to about 765 kV.

3. The high-voltage assembly of claim 2, wherein the high-voltage environment is about 100 kV to about 765 kV.

4. The high-voltage assembly of claim 1, wherein the thermoplastic vulcanizate comprises a thermoplastic and an elastomer.

5. The high-voltage assembly of claim 4, wherein the thermoplastic is selected from the group consisting of polypropylene, nylon, polyethylene, and ethylene-co-vinyl acetate.

6. The high-voltage assembly of claim 5, wherein the thermoplastic is ethylene-co-vinyl acetate or polyethylene.

7. The high-voltage assembly of claim 4, wherein the thermoplastic vulcanizate comprises the thermoplastic at about 10 weight percent (wt %) to about 90 wt % based on the total weight of the thermoplastic vulcanizate.

8. The high-voltage assembly of claim 4, wherein the elastomer is selected from the group consisting of silicone, ethylene propylene diene monomer (EPDM), ethylene propylene rubber (EPM), fluorosilicone, polyvinylidene difluoride, natural rubber, and nitrile butadiene rubber.

9. The high-voltage assembly of claim 8, wherein the elastomer is silicone.

10. The high-voltage assembly of claim 4, wherein the thermoplastic vulcanizate comprises the elastomer at less than 50 wt % based on the total weight of the thermoplastic vulcanizate.

11. The high-voltage assembly of claim 4, wherein the thermoplastic vulcanizate comprises the elastomer at about 10 wt % to about 90 wt % based on the total weight of the thermoplastic vulcanizate.

12. The high-voltage assembly of claim 4, wherein the elastomer is at least partially cured.

13. The high-voltage assembly of claim 4, wherein the thermoplastic vulcanizate comprises silicone and ethylene-co-vinyl acetate.

14. The high-voltage assembly of claim 1, wherein the thermoplastic vulcanizate comprises a functional filler selected from the group consisting of a flame retardant, a chemical stabilizer, a UV protectant, a heat stabilizer, a compatibilizer, a plasticizer, and a combination thereof.

15. The high-voltage assembly of claim 1, wherein the housing is recyclable.

16. The high-voltage assembly of claim 1, wherein the component is an arrester, a transmission and distributor insulator, a polymer cut-out, a fusing, a bushing, or an interrupter.

17. The high-voltage assembly of claim 16, wherein the component is a transmission and distributor insulator.

18. A high-voltage assembly comprising:
a component capable of operating in a high-voltage environment; and
a housing at least partially enclosing the component, the housing consisting essentially of a thermoplastic vulcanizate and an optional functional filler.

19. A method of making a high-voltage assembly, the method comprising:
providing a thermoplastic vulcanizate; and
overmolding the thermoplastic vulcanizate onto a component capable of operating in a high-voltage environment.

20. The method of claim 19, wherein providing the thermoplastic vulcanizate comprises mixing a thermoplastic and an elastomer to provide a mixture and dynamically vulcanizing the mixture to provide the thermoplastic vulcanizate.
